(19) United States
(12) Patent Application Publication
(10) Pub. No.: US 2008/0007840 A1
(43) Pub. Date: Jan. 10, 2008

(54) Optical apparatus and methods for chemical analysis

(75) Inventors: John H. Kepler, Combridge, MA (US); Aaron Weber, Cambridge, MA (US); Parris Saxon Wellman, Reading, MA (US)

Correspondence Address: COOLEY GODWARD KRONISH LLP;ATTN: Patent Group, Suite 1100, 777 - 6th Street, NW, WASHINGTON, DC, 20001, US

(73) Assignee: Helicos Biosciences Corporation, Cambridge, MA (US)

(21) Appl. No.: 11/598,516

(22) Filed: Nov. 13, 2006

Related U.S. Application Data
(62) Division of application No. 11/481,403, filed on Jul. 5, 2006.

(51) Int. Cl. G02B 13/22

(52) U.S. Cl. 359/663

(57) ABSTRACT

In one aspect, the invention relates to an optical apparatus for producing light of a predetermined intensity from light sources of less than the predetermined intensity. In one embodiment the apparatus includes a first light source; a second light source; a double dove anti-Gaussian generator in optical communication with the first light source; and a compensator in optical communication with the second light source. Light from the first light source passes through the double dove anti-Gaussian generator and light from the second light source passes through the compensator, and are combined to produce a flattened Gaussian intensity distribution. In another aspect, the invention relates to a method and apparatus for separating an image into subunits and reading the separate subimages out of the detectors in parallel.

### FIELD OF THE INVENTION

The invention relates generally to optical devices and techniques for improving the operation of optical analytic devices. In particular, the invention relates to high intensity light sources for imaging a sample and improved image detection to speed data capture.

### BACKGROUND OF THE INVENTION

Many analytical applications require an intense beam of light to illuminate a sample in order to produce a weak emission of light by the sample. This emitted light is typically then detected to indicate the presence of some moiety in the sample. As an example, fluorescent probes are used to detect the binding of the probe to a single target molecule within a sample. In this example, light of sufficient intensity is required to obtain a suitable level of fluorescence from the bound probe in order to detect the single target molecule.

The use of single molecule analysis, for example, permits a researcher to analyze the sequence of bases in a nucleic acid strand by building a complementary strand to the nucleic acid of interest, one base pair at a time, using fluorescent labeled bases and determining which base has been incorporated. By performing this operation on thousands of single molecule nucleic acid targets simultaneously, one can sequence a large genome in a relatively short period of time.

Typically, high intensity light is produced by a large high-power laser which tends to be fairly expensive, heavy, requires a large amount of space, and often requires water cooling because of its low efficiency. Similarly, the detection of images of weak emitted light tends to require large and expensive arrays of detectors. These detector arrays typically require a long readout time and hence reduce the number of samples which may be analyzed in a given period of time. A need therefore exists for devices and methods that facilitate single molecule detection by addressing the light generation and signal detection issues discussed above.

### SUMMARY OF THE INVENTION

In one aspect, the invention relates to an optical apparatus for producing light of a predetermined intensity from light sources of less than the predetermined intensity. In one embodiment, the apparatus includes a first light source; a second light source; a double dove anti-Gaussian generator in optical communication with the first light source; and a path length compensator in optical communication with the second light source. Light from the first light source passes through the double dove anti-Gaussian generator; light from the second light source passes through the path length compensator and both are then combined to produce light having a flattened Gaussian intensity distribution.

In a further aspect, the invention relates to an optical source. The optical source includes a first light source adapted to produce light having a first profile, a second light source adapted to produce light having a second profile, a path length compensator in optical communication with the first light source, the path length compensator adapted to transmit light having a third profile, a double dove prism in optical communication with the second light source, the double dove prism adapted to transmit light having a fourth profile; and a combiner assembly adapted to receive light having the third and fourth profiles and transmit light having a modified Gaussian profile.

In another aspect, the invention relates to a method of combining light from multiple light sources to increase its intensity. In one embodiment the method includes the steps of: passing light from a first light source through a double dove anti-Gaussian generator; passing light from a second light source through a path length compensator; and combining light from the first light source and from the second source to produce a flattened Gaussian intensity distribution.

In yet another aspect, the invention relates to an apparatus and method for taking multiple images projected from an object. In one embodiment, the apparatus includes a reflector having a plurality of reflective surfaces; a plurality of telecentric lens systems, each in optical communication with a respective one of the reflective surfaces of the reflector; and a plurality of image detectors, each of the image detectors in optical communication with a respective one of the telecentric lens systems. Each of the plurality of telecentric lens systems is positioned between the respective reflective surface and the respective image detector. Light from the object is reflected from the plurality of reflective surfaces and passed through the respective telecentric lens systems to the respective image detectors. In one embodiment, the reflector is a shallow pyramidal reflector having four reflective surfaces.

In still yet another aspect, the invention relates to a method for taking multiple images projected from an object. In one embodiment, the method includes reflecting light received from the object by a reflector having a plurality of reflective surfaces; passing the light reflected by each of the reflective surfaces through a respective telecentric lens system of a plurality of telecentric lens systems; and capturing the light reflected by each of the reflective surfaces and passed through each of the respective telecentric lens systems by a respective image detector of a plurality of image detectors.

In another embodiment, an apparatus for taking multiple images projected from an object includes a light collector having a plurality of optical fiber bundles; and a plurality of image detectors, each respective image detector of the plurality of image detectors in optical communication with a respective one of the optical fiber bundles. Light from the object is transmitted by each of the optical fiber bundles to its respective image detector.

Still yet another aspect of the invention relates to an apparatus for taking multiple images projected from an object. In one embodiment, the apparatus includes a light collector having a plurality of optical fiber bundles and a plurality of image detectors, each respective image detector of the plurality of image detectors in optical communication with a respective one of the optical fiber bundles. Light from the light source is transmitted by each of the optical fiber bundles to the respective image detector.

In a still further aspect, the invention relates to an image capture apparatus adapted to transform one image of an object into a plurality of sub-images. The apparatus includes a plurality of optical waveguides, each having a respective receiving endface and each having a respective transmitting endface. The receiving endfaces are arranged to form an endface plane, each receiving endface adapted to receive light emitted from a position disposed on the sample plate, and each transmitting endface in optical communication with one respective image detector.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a block diagram illustrating an analytic device adapted for using embodiments of the invention;

FIG. 2 is a schematic diagram of an embodiment of the intense light source generator of the invention;

FIG. 2a is a schematic diagram of the path of a light ray through a dove prism;

FIG. 2b is a schematic diagram of the Gaussian intensity profile for a light source before and after it passes through a double dove prism;

FIG. 2c is a schematic diagram of the emitting face of a diode laser and the Gaussian intensity profile across the facet and the variable intensity profile along the facet;

FIG. 3 is a perspective schematic diagram of an embodiment of the fast readout image detection subsystem of the invention;

FIG. 4 is a perspective schematic diagram of another embodiment of the fast readout image detection subsystem of the invention;

FIG. 5 is a detailed schematic diagram of the optical portion of the system of FIG. 1 using light ray combining and image translation subsystem embodiments of the invention;

FIG. 5b is a detailed schematic diagram of another embodiment of the system of FIG. 5; and

FIG. 6 is a block diagram of an embodiment of the fluidics portion of the system constructed in accordance with the invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

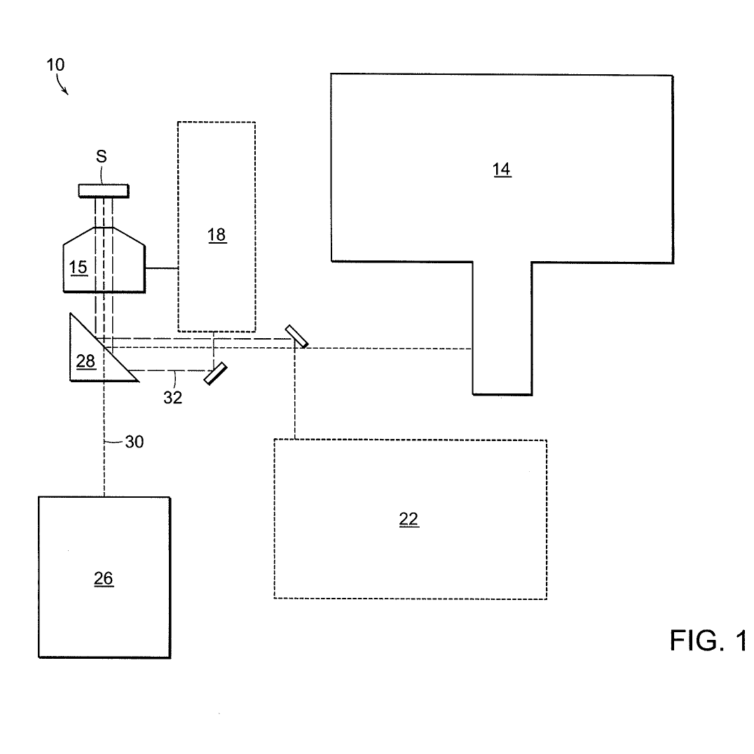

In general, the invention relates to various optical systems and methods for performing molecular analysis, such as base pair sequencing. Although various aspects and embodiments of the invention are disclosed herein, for organizational purposes, they can be grouped into two general categories. The first category relates to apparatus and methods for increasing available light intensity while reducing the size of the overall system and increasing the efficiency (power input required to light output produced) while simultaneously eliminating the need for water cooling. The second category relates to dividing an optical image of an object into a plurality of sub-images for processing by a plurality of detectors. This second category can be divided into two sub-categories based on whether the image division is carried out using an optical fiber based approach or a reflector approach. Each of these approaches is discussed in turn in more detail below. However, some of these general categories of inventive aspects can be seen in the exemplary system shown in FIG. 1.

As shown in FIG. 1, a highly schematic block diagram of an exemplary optical system 10 suitable for performing single molecule sequencing of a sample S is illustrated. In one embodiment, the sample array plate S includes a plurality of single molecules arranged in a grid formation such that the attachment of fluorescent probes to each of the single molecules on the plate can be indexed and tracked. As shown, the optical system 10 includes a plurality of subsystem components: light source subsystem 14; auto-focus subsystem 18; alignment subsystem 22; and an imaging subsystem 26.

Typically, light that is used to illuminate the sample array plate S originates at the light source subsystem 14. In order to reduce the size of the overall system 10, the intense light required to cause samples on the sample plate to fluoresce is generated by two or more laser diodes or other suitable sized light generating components located within the light source subsystem 14. The light source subsystem 14 combines light from the plurality of laser diode sources to provide a single light beam of a sufficient intensity suitable for causing fluorescence of the single molecules on the sample plate S. In addition, in one embodiment, the light source subsystem 14 includes components which cause the spatial intensity of the beam to be more uniform.

The light generated by the light source subsystem 14 is directed to the sample array plate S by an optical component 28 so as to excite fluorescence in the probes attached to the samples mounted on the sample array plate S. In turn, fluorescent light emitted from the fluorescent probes attached to the sample array plate S, in response to the incident excitation light, is directed back along optical path 30 to a detector subsystem 26. The detector subsystem 26 includes a single array detector capable of imaging the entire plate or a group of smaller arrays as will be discussed below in more detail.

The auto-focus subsystem 18 includes a laser source having a different wavelength from that of the excitation light source 14. For example, the auto-focus subsystem 18 in one embodiment uses infrared light. The auto-focus subsystem 18 includes mechanical components for moving lens 15 relative to the sample array plate S. Light from the auto-focus laser travels along optical path 32 and reflects from the sample array plate S. The reflected light reverses its direction and is detected by a detector within the auto-focus subsystem 18. If the auto-focus subsystem 18 detects that the sample array plate S is out of focus, the auto-focus subsystem 18 moves the lens 15 relative to the sample array plate S to assure the image detected by detector subsystem 26 is in focus.

Alignment subsystem 22 images light from the sample array plate S so as to assure alignment of the various optical systems. The alignment subsystem 22 will also be described in more detail below.

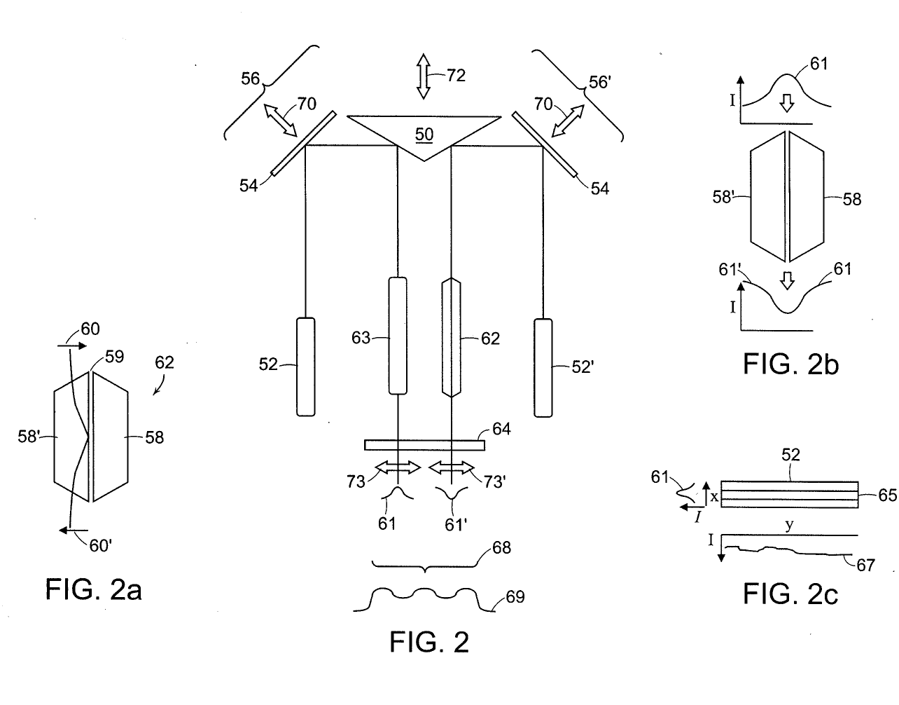

FIG. 2 is a block diagram of an embodiment of a light source subsystem 14 of the invention. More specifically, FIG. 2 illustrates a light source subsystem 14 constructed of two light sources suitable for generating light with the desired frequency and intensity. The resultant light is used to illuminate the sample array plate S so as to cause fluorescent emission that can be recorded as an image and ultimately captured by the detector subsystem 26 of FIG. 1. In this embodiment, two laser diodes 52, 52′ (generally 52) are used as the primary light sources. In the embodiment shown, the laser diodes 52, 52′ are positioned adjacent a pair of retroreflectors 56, 56′ (generally 56) constructed of two mirrors 54, 54′ (generally 54) and triangular reflector 50 respectively. Light from the diode laser 52 is reflected from a mirror 54 on to the surface of the reflector 50 and directed back in the direction of the diode laser 52 completing the path through the retroreflector 56.

The path the light takes from one of the laser diodes 52′ through the retroreflector 56′ passes through a double dove prism anti-Gaussian generator 62. Referring also to FIG. 2a, a double dove prism anti-Gaussian generator 62 includes two dove prisms 58, 58′ positioned adjacent one another with a small spacing 59 between them. Consider what happens to image (arrow) 60 as it passes through one prism 58′. The light from the image 60 is refracted and undergoes total internal reflection at the interface between the prisms 58′ before being refracted again. This light path causes the image of the arrow 60 to invert 60′. If the image is a Gaussian intensity distribution (FIG. 2b) the intense portion in the middle 61 of the distribution will be inverted by the each of the dove prisms 58, 58′ and appear at the edges of the inverted image 61′, while the darker edges of the distribution will appear in the middle of the inverted image. Thus the image of a Gaussian light intensity distribution, with dark edges and a bright center, from the laser diode 52′ will appear inverted, with bright edges dark center, after passing through the double dove prism. This inversion is termed an anti-Gaussian distribution.

Referring to FIG. 2c, the emitting facet 65 of a diode laser 52′ and the Gaussian intensity profile 61 across the facet 65 and the variable intensity profile 67 along the facet 65 is depicted. Thus light from the facet 65 produces the Gaussian profile of FIG. 2b which is inverted by the anti-Gaussian generator 62 as shown in FIGS. 2 and 2b.

Light from the other diode laser 52 passing through retroreflector 56 is sent through a path length compensator 63, which is typically a piece of glass having the same refractive index as the anti-Gaussian generator 62 and of approximately the same length. The Gaussian profile 61 of the light from the diode laser 52 is retained as the light passes through the path length compensator 63. The light from both paths is then combined 68 (as described below) to produce a flattened Gaussian intensity distribution 69. This flattened Gaussian distribution is thus a more uniform source of light than either of the lasers 52 alone.

In addition the non-uniformity of light intensity 67 along the facet 65 of the diode laser 52 can be made more uniform by repetitively moving the reflective surface 56, 56′ corresponding to the laser 52, 52′ respectively in the direction shown by arrows 70, 70′. Alternatively, the triangular reflector 50 can be moved in the direction shown by arrow 72. These movements cause the beam from the lasers 52, 52′ to move as shown by arrows 73, 73′. The sweeping of the beam causes a detector viewing a portion of the light from the elongated facet 65 to see a sweep of light that is an average of the light intensity across a portion of the facet 65. This technique is fully described in co-pending U.S. patent application Ser. No. 11/370,605, filed Mar. 8, 2006 and assigned to the common assignee of the instant application, and is herein incorporated by reference.

The combination of the anti-Gaussian generator 62 and the movable reflectors 54, 54′ or 50, therefore produce a fairly uniform light beam 69 from the laser diodes 52, 52′ that have Gaussian 61 and non-uniform 67 emission profiles from the various axes of their facets 65.

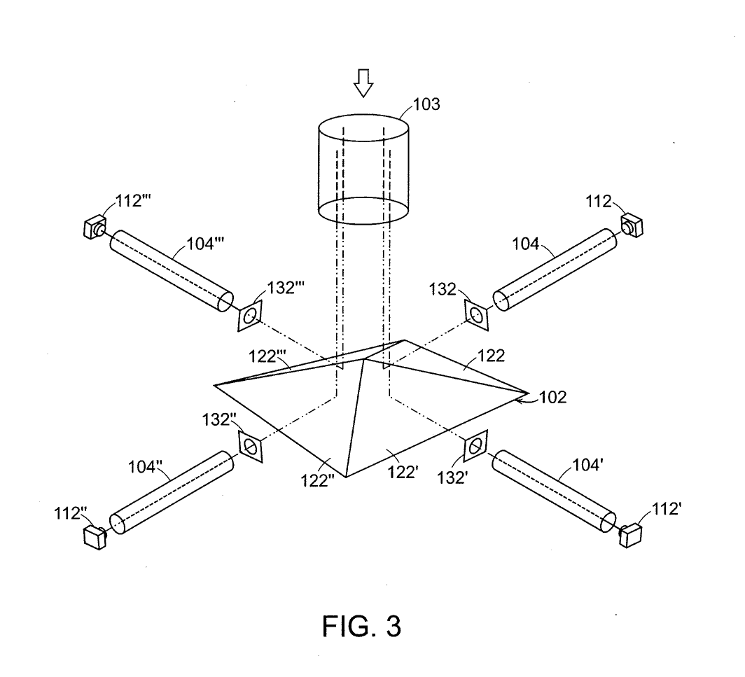

Referring to FIG. 3, a perspective schematic diagram of one embodiment of an imaging subsystem is shown. The imaging system includes a shallow four sided pyramidal reflector 102, a tube lens system 103, four telecentric lens systems 104, 104′, 104″, 104′″ (generally 104), four apertures 132, 132′, 132″, 132′″ (generally 132) and four image detectors 112, 112′, 112″, 112′″ (generally 112). An image from a sample (arrow) is focused by the tube lens 103, to form an image onto the facets 122 of shallow pyramidal reflector 102. A portion of the image, reflected by each facet 122 of the pyramidal reflector 102, passes through a respective aperture 132 and telecentric lens system 104 and is then captured by the respective image detector 112.

In various embodiments, the number of facets 122, telecentric lens systems 104 and image detectors 112 may vary, and other appropriately-shaped reflectors may be used to provide the desired number of reflective surfaces. As a result, one sample plate image can be divided into a plurality of sub-images for capture and readout by a plurality of detectors operating in parallel. This is an important consideration when the detectors used are charge coupled devices. In a charge coupled device, the pixel values are read out sequentially. For large arrays this may result in a significant time delay. By using multiple arrays, each array can be read out concurrently with the other arrays, decreasing the readout latency for the whole image. Once each of the arrays has been read out the entire image can be reformed by combining the subimages digitally.

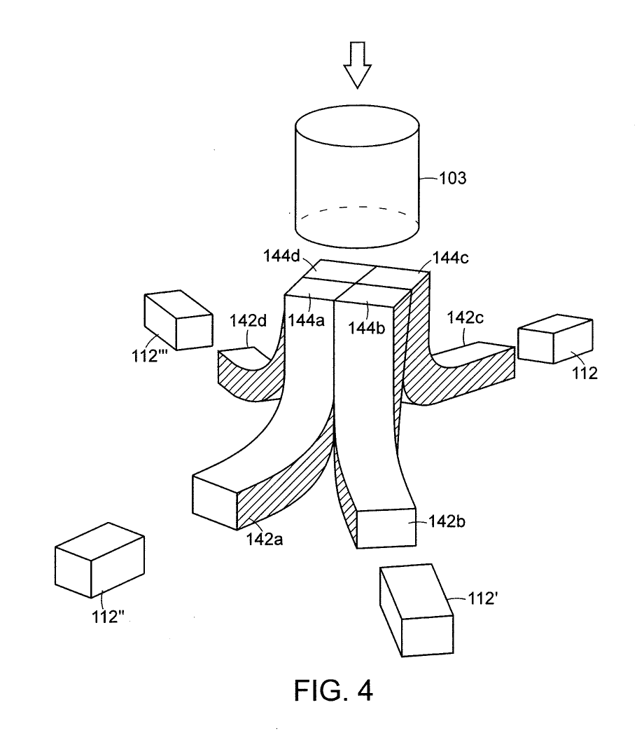

Referring to FIG. 4, in this embodiment the reflector 102 depicted in FIG. 3 has been replaced with four bundles of optical fibers 142a, 142b, 142c, and 142d (generally 142). In these bundles 142, the optical fibers remain parallel to one another and are not twisted. This permits an image at one end of the bundle to be viewed without distortion at the other end of the bundle. The first end 144 (a-d) of each bundle 142, is positioned adjacent to one another to cover the image field of interest. The four bundles 142 then separate to bring their respective portion of the images to their respective detectors 112.

In use, a single microscope image is split among multiple detectors. In turn, this speeds data collection as a result of each detector 112 being read in parallel in contrast with one large detector being read serially.

If the diameters of the fibers in a bundle 142 are smaller than that of the pixels of the detector 112, then additional optical components are needed to expand the image. If the diameters of the fibers are larger than the pixels of the detector 112, then the image exiting the fiber bundle 142 can be reduced in size and imaged onto the detector 112 to avoid sampling problems such as pixel-sample component misalignment.

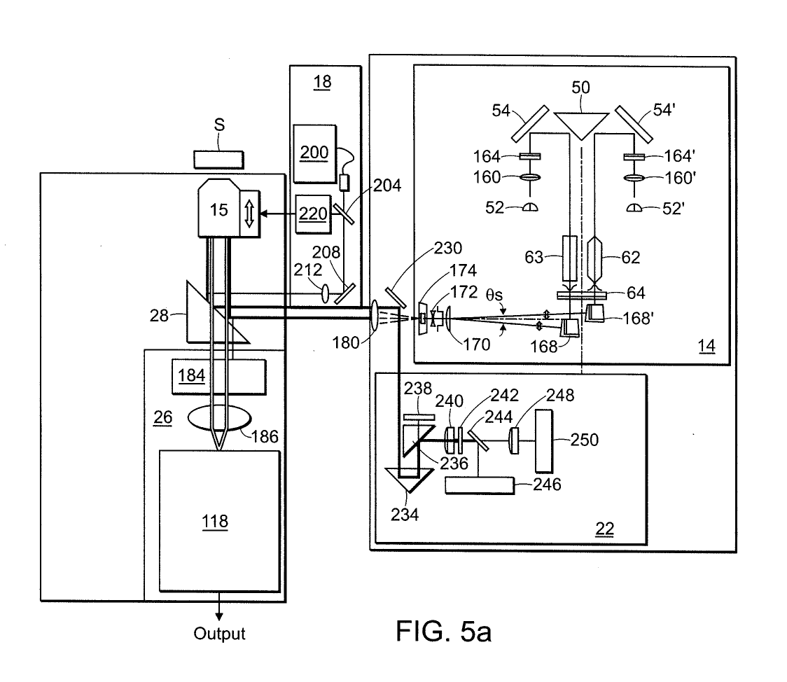

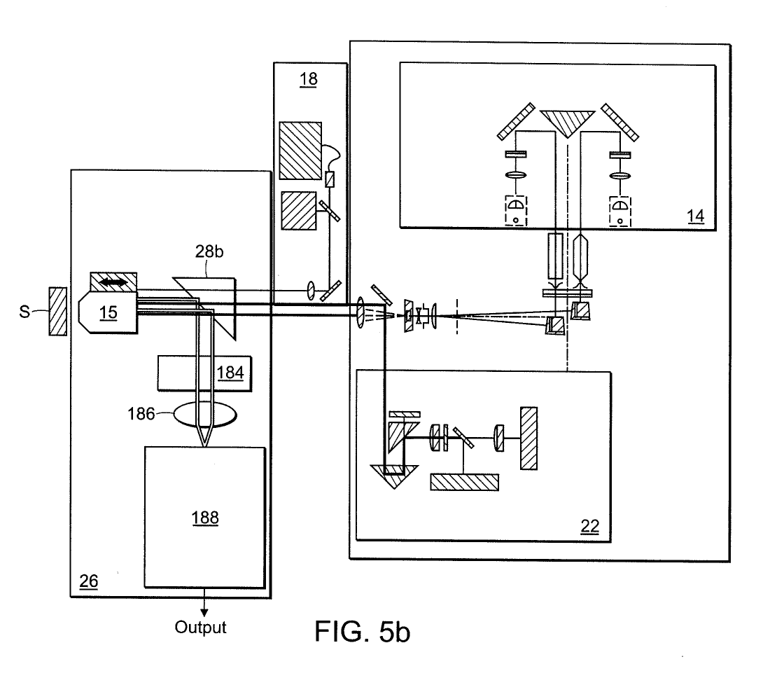

Referring now to FIG. 5, a detailed schematic diagram of an imaging system 10, suitable for detecting emitted light from a sample plate S according to an embodiment of the invention is shown. FIG. 5 represents a more specific representation of the embodiment of the system shown in FIG. 1. In this embodiment, the imaging system 10 again includes four major subsystems: an illumination subsystem 14 including an optical source formed from two symmetric light source assemblies, an auto-focus optics subsystem 18, an alignment subsystem 22, and an imaging subsystem 26. Light emitted from the laser diodes 52, 52′ of the optical source 14 is tuned by the elements in the illumination subsystem 14 to have a flattened Gaussian intensity distribution, focused on the sample S, and the fluorescence captured by the imaging subsystem 26. Although not shown, the focusing subsystem 18 is in mechanical communication with TIRF objective 15.

In more detail, in this embodiment, the optical source subsystem 14 includes pair of laser diode modules 52, 52′ that emit light in the 635 nm range. The light beam from each laser diode 52, 52′ passes through a weak positive lens 160, 160′, respectively, and through a respective positive cylindrical lens 164, 164′ before passing through a retroreflector constructed of two mirrors 54, 54′ oriented at forty-five degrees to the beam path. The two light beams are then reflected by the triangular mirror 50 through the compensation prism 63 and the double dove anti-Gaussian generator 62. The two beams pass through a positive curvature cylindrical lens 64 into steering mirrors 168, 168′ having eight tilt adjustments. The steering mirrors 168,168′ direct the beams toward a positive cylindrical lens 170, which, along with a diverging lens 172, a field aperture 174 and a TIRF lens 180 combines the two light beams into a single beam which is reflected by a beam splitting dichroic 28.

Light reflecting from the dichroic 28 passes through the objective lens 15 to the sample plate S. Light emitted from the sample plate S passes through the dichroic 28 to enter the imaging subsystem 26.

An alternative embodiment is shown in FIG. 5b. Here the laser is brought straight through the back of the dichroic, 26b, and the imaging light is reflected off the front surface and transmitted to the camera, 188. This is advantageous because the imaging path is most sensitive to optical aberrations and eliminating the need to pass through the glass reduces the requirements for glass homogeneity which makes the dichroic easier to manufacture.

Light entering the imaging subsystem is first passed through a notch filter 184 to remove any of the excitation light from the diode lasers 52, 52′ and through a tube lens 186 before reaching the camera 188. Note that after the light passes through the tube lens 186, the camera may take the form of a single large CCD array or a plurality of CCD arrays and optics as shown in FIGS. 3 and 4. Thus, the camera 188 forms images which are output for processing and storage.

Considering the focus subsystem 18 next, the subsystem 18 includes an 830 nm laser 200 which produces a light beam that passes through a beamsplitter 204 and is reflected by a mirror 208, through a lens 212. The light is reflected by dichroic 28 and passes through the objective 15 to the sample plate S. The image of the sample plate S is reflected by the dichroic 28 back through the lens 212 to be reflected by the mirror 208. The reflected light passes to the beam splitter 204 to be reflected to the detector 220. The detector 220 receives the light and adjusts the position of the objective 15 relative to the sample plate S based on the focus of the image, as discussed in pending application Ser. No. 11/234,420 filed Sep. 23, 2005 and assigned to the assignee of the present application and herein incorporated by reference.

With respect to the alignment subsystem 22, the image returning from the objective 15 is partially reflected by the dichroic 28, through lens 180 to a switchable pickoff mirror 230. When in place the pickoff mirror 230 reflects the image to a retroreflector 234 which reverses the beam direction. The image beam is then partially reflected by a beam splitter 236. The remainder of the beam is absorbed by a “beam-dump” 238. The reflected portion of the image passes through a lens 240 and a filter 242 to a second beam splitter 244. A portion of the image is reflected by the beam splitter 244 to a pupil camera 246, while the remainder of the beam image 248 passes through a lens 240 to a field camera 250. The two cameras 246, 248 permit the image to be detected and the alignment determined.

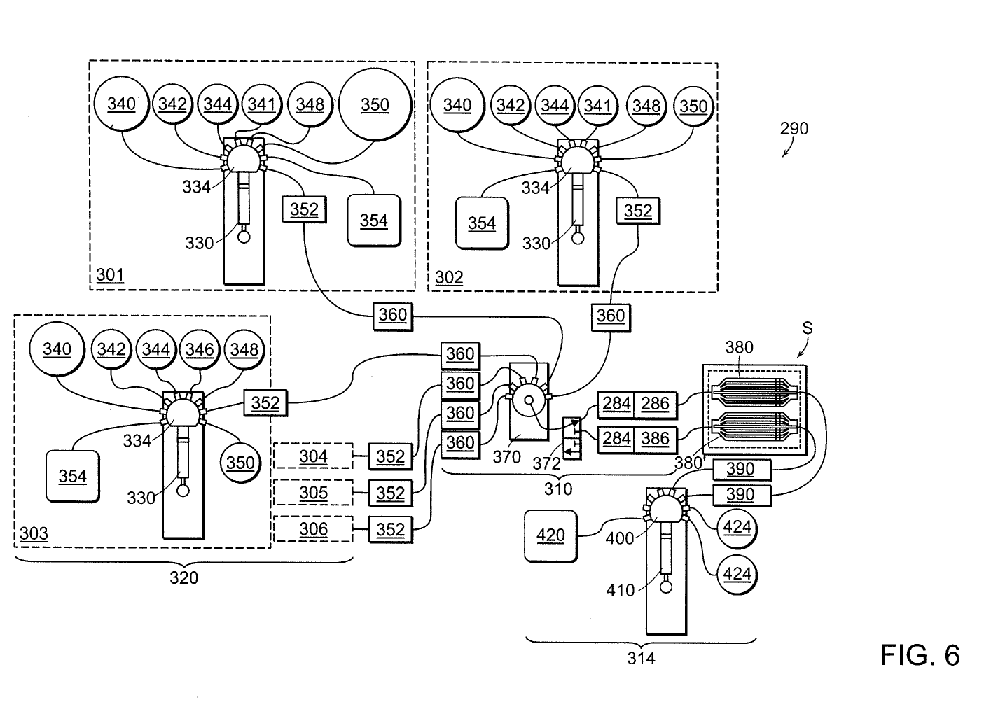

Referring to FIG. 6, the fluidics portion 290 of the system is depicted. The fluidics portion 290 moves the reagents and nucleotides onto the sample plate S as the sequencing proceeds. In the embodiment shown there are six source pump subsystems 301, 302, 303, 304 305, and 306; a central mixing valve subsystem; the sample plate S, and the sink pump subsystem 314. A group 320 of four of the six source pump subsystems 303, 304, 305, and 306 provide the individual nucleotides C, U, A, G respectively to the flow cell sample plate S. One source pump subsystem 301 provides the scavenger reagents while the remaining source pump subsystem 302 provides the “bulk” reagents.

Each source pump subsystem includes a syringe pump 330 connected to a valve 334. The valve 334 controls the flow of reagents from the reagent sources 340, 342, 344, 346, 348 and 350 to the central mixing valve subsystem 310 through a bubble detector 352. Waste from the flushing of the source pump subsystem is directed by the valve 334 to a waste tank 354.

Reagents pumped by a source pump subsystem combine in a respective mixer 360, in the central mixing valve subsystem 310, prior to being presented to the central valve 370. An output switch 372 connects one of the flow cells 380, 380′ at a time to the central valve 370 through a pressure relief chamber 384 and a pressure sensor 386. The output of the flow cells 380, 380′ are connected to a sink control value 400 in the sink pump subsystem 314. A syringe sink pump 410 draws the fluid through the flow cell 380, 382 and pumps it into a waste sink 420. Reagent sources 424 provide reagents to flush the syringe pump 410 and the sink control valve 400.

In another embodiment, the mixers 360 of the central mixing valve subsystem 310 are not used and instead the chamber of the individual syringe pumps 330 are used to carryout the mixing of the reagents. In this embodiment a portion of the volume of the reagent being used in the largest volume in the protocol is drawn into the syringe pump 330. This bolus is followed by the full amounts of the smaller reagent volumes of the protocol. The larger reagent volume insures that the smaller volumes do not adhere to the sides of the syringe chamber. Once the last of the smaller reagent volumes has been added, the remaining amount of the largest volume reagent is drawn into the chamber at such a rate that the flow of the reagent into the syringe is transitional or turbulent. This turbulence causes all of the reagents to mix.

In one embodiment, the syringe pump volume is 250 μl and the aspirated large volume of reagent is 60 μl. This volume is drawn at a rate of between 50 μl/sec and 240 μl/sec. The rate is chosen so that the Reynolds number of the fluid flow is greater than 2300 and generally between 3000-4000 for the reagent being aspirated.

In operation, reagents are drawn by the syringe pumps 330 through the valves 334 from the reagent sources into their respective mixing chambers 360. The syringe sink pump 410 draws the reagents through the flow cells 380 by applying negative pressure to the central valve 370 according to the protocol used to sequence the target sample. The pumps and valves are operated under processor control under this protocol which also controls the acquisition of images.

While the invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

What is claimed is:

1-9. (canceled)

10. A fluidic reagent dispensing system comprising:
a plurality of reagent reservoirs;
a syringe pump having a plurality of controllable ports, each of said reagent reservoirs in communication with a respective one of the plurality controllable ports, one of said plurality of controllable ports being an output port;
a bubble detector in communication with said output port; and
a controller in communication with said syringe pump, said controller controlling the controllable ports, volume of aspiration and aspiration rate of said syringe pump.

11. The fluidic reagent dispensing system of claim 10 wherein said syringe pump comprises a chamber and said controller is set to draw reagent from at least one of said a plurality of reagent reservoirs into said chamber in one of a transitional and turbulent manner.

12. The fluidic reagent dispensing system of claim 11 wherein the Reynolds number for flow of the reagent during aspiration is greater than 2300.

13. The fluidic reagent dispensing system of claim 10 further comprising a mixing chamber in communication with said bubble detector.

14. A method of dispensing fluid reagents in a fluid reagent system comprising the steps of:
drawing a first volume of a first reagent from a first reagent reservoir into a chamber of a syringe pump; and
drawing a second volume of a second reagent from a second reagent reservoir into said chamber of said syringe pump, said second volume being larger than said first volume,
wherein the rate at which the second volume is drawn into said chamber is sufficient to cause one of transitional and turbulent flow of said second reagent.

15. The method of claim 14 wherein the Reynolds number for flow of the second reagent is greater than 2300.
